(19) United States
(12) Patent Application Publication
(10) Pub. No.: US 2011/0037619 A1
(43) Pub. Date: Feb. 17, 2011

(54) Traffic Routing Using Intelligent Traffic Signals, GPS and Mobile Data Devices

(75) Inventors: Matthew L. Ginsberg, Eugene, OR (US); Matthew M. Austin, Eugene, OR (US); Paul A.C. Chang, Springfield, OR (US); Stephen C. Mattison, Lynden, WA (US)

Correspondence Address: FENWICK & WEST LLP, SILICON VALLEY CENTER, 801 CALIFORNIA STREET, MOUNTAIN VIEW, CA, 94041, US

(73) Assignee: ON TIME SYSTEMS, INC., Eugene, OR (US)

(21) Appl. No.: 12/639,770

(22) Filed: Dec. 16, 2009

Related U.S. Application Data
(60) Provisional application No. 61/233,123, filed on Aug. 11, 2009.

(51) Int. Cl. G08G 1/07

(52) U.S. Cl. 340/910

(57) ABSTRACT

A traffic routing system reduces emissions from commuter and other traffic, eases congestion on roadways, and decreases transit time by use of communications among vehicles and traffic controls, such as traffic lights. In one aspect, a traffic light receives a signal that a vehicle is approaching and in response turns green to allow the vehicle to pass without impairment. In another aspect, a vehicle receives a signal to adjust a current rate of speed to arrive when a traffic signal allows vehicles to pass. In still another aspect, a combination of congestion, emergency traffic, roadwork and similar factors influence proposed routes sent to vehicles.

### RELATED APPLICATION

This application is related to U.S. Provisional Patent Application No. 61/233,123 filed Aug. 11, 2009, and claims priority therefrom pursuant to 35 U.S.C. §120.

### FIELD OF INVENTION

The present invention relates generally to traffic control systems and traffic routing.

### BACKGROUND

Significant reductions in vehicle emissions can be achieved, congestion can be limited, safety can be enhanced and travel times reduced by helping commuters and other drivers choose uncongested routes to their destinations. Numerous schemes have been proposed in the past for informing drivers of traffic conditions and presenting them with proposed alternatives when congestion is found. For example, traffic helicopters have been used for decades by radio stations to spot areas of congestion and suggest alternate paths that drivers may wish to consider.

With the growing popularity of GPS and hand-held computing devices, particularly those connected to cellular networks or the internet, other approaches have been used, such as graphical representations of maps with routes being color-coded to indicate levels of congestion.

Another approach to the traffic congestion problem involves “smart” traffic signals. For instance, railroad crossings have for decades been tied to traffic signals to help ease the flow of traffic on routes adjacent to railroad crossings when a train approaches. Further, certain systems have been installed that allow emergency vehicles such as fire trucks to change the state of a light from red to green so that the emergency vehicle can cross the intersection quickly with, rather than against, the signal.

In still another related area, various attempts have been made to collect traffic information from drivers who have, for example, GPS-enabled smartphones with them in their vehicles. Typically, such drivers do not find sufficient incentive to start up, and keep running, an application that will transmit their speed and location information to a remote traffic database.

No known approaches fully integrate the technologies that are available to report traffic information to drivers and suggest routes based on that information, to communicate with traffic signals, and to collect traffic information from drivers.

### SUMMARY

A traffic routing system includes communications among vehicles and traffic controls, such as traffic lights. In one aspect, a traffic light receives a signal that a vehicle is approaching and in response turns green to allow the vehicle to pass without impairment. In another aspect, a vehicle receives a signal to adjust a current rate of speed to arrive when a traffic signal allows vehicles to pass. In still another aspect, a combination of congestion, emergency traffic, roadwork, accidents, weather and similar factors influence proposed routes sent to vehicles. In a further aspect, a vehicle operator is presented with a display of a predicted state of a traffic light that varies with intensity as the prediction becomes more certain. In yet another aspect, the system changes an existing route based on changes in predicted state of one or more traffic lights, for instance due to unanticipated pedestrian requests for a “walk” state of a traffic light. By maintaining information of interest to vehicle operators during approach, the operators are provided incentive to continue use of the system in an ongoing manner that permits collection of the vehicle's real-time speed and location data for related traffic reporting and routing purposes.

### BRIEF DESCRIPTION OF THE DRAWINGS

FIG. 1 is a high-level block diagram of the computing environment in accordance with an embodiment of the invention.

FIG. 2 is a block diagram of a user device, in accordance with an embodiment of the invention.

FIG. 3 is a block diagram of a traffic signal, in accordance with an embodiment of the invention.

FIG. 4 is a block diagram of a controller, in accordance with an embodiment of the invention.

FIG. 5 is a block diagram illustrating an example of a computer for use as a user device, a traffic signal, or a controller, in accordance with an embodiment of the invention.

FIG. 6 is a flow chart illustrating a method of providing improved traffic routing, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the present invention provide systems, methods, and computer-readable storage media that use location-based technologies such as GPS or cellular to provide improved traffic routing. Embodiments include one-way or two-way communication between traffic signals and drivers, and between drivers and a traffic database. Drivers are equipped with user devices that report their location to a controller for at least one traffic signal and optionally also report the driver's destination. The traffic signals are controlled by the controller to advantageously cycle through green and red lights according to a desired impact on traffic conditions for vehicles moving through the controlled intersection. In one implementation, the controller also sends information to the user devices to suggest the fastest route to the driver's destination, the time until a traffic signal turns green or red, a suggested speed to travel to arrive at a controlled intersection when the light is green, and/or a variety of other directions to improve traffic routing.

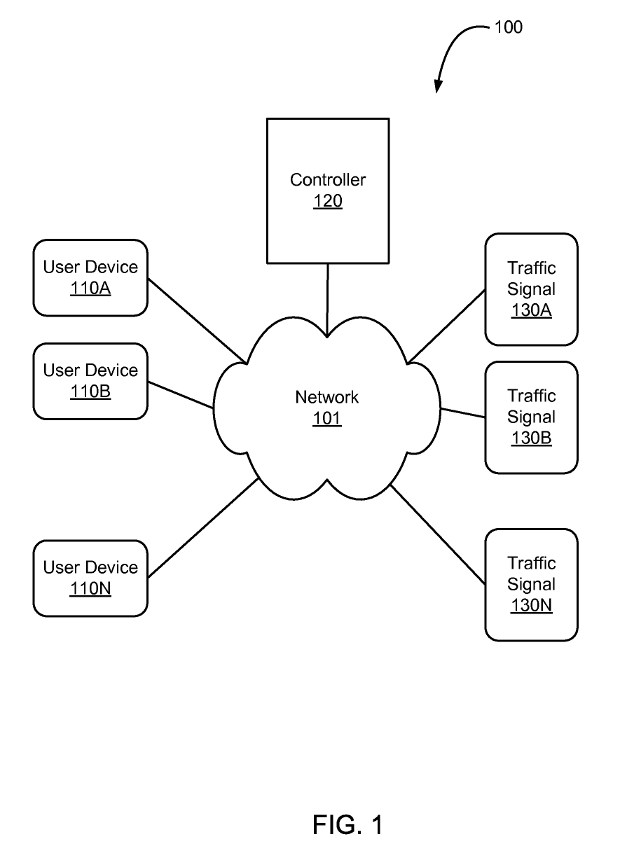

FIG. 1 is an illustration of a system 100 in accordance with one embodiment of the invention. The system 100 includes a plurality of user devices 110A-N, that are coupled to a network 101. In various embodiments, user devices 110 may include a computer terminal, a personal digital assistant (PDA), a wireless telephone, an on-vehicle computer, or various other user devices capable of connecting to the network 101. In various embodiments, the communications network 101 is a local area network (LAN), a wide area network (WAN), a wireless network, an intranet, or the Internet, for example. In one specific embodiment, user device 110 is an iPhone® device provided by Apple, Inc. and programmed with a user-downloadable application providing one or more of the functions described herein.

The system 100 also includes a plurality of traffic signals 130A-N that are connected to the network 101 and at least one controller 120. In one embodiment, the traffic signals 130A-N are all the traffic signals for all the controlled intersections in a local area. In one implementation, the controller 120 controls the operation of all the traffic signals 130A-N in the system. Alternatively, one controller 120 may control a subset of all the traffic signals 130A-N, and other controllers may control a portion or all of the remaining traffic signals. In still another embodiment, system 100 does not control any traffic lights.

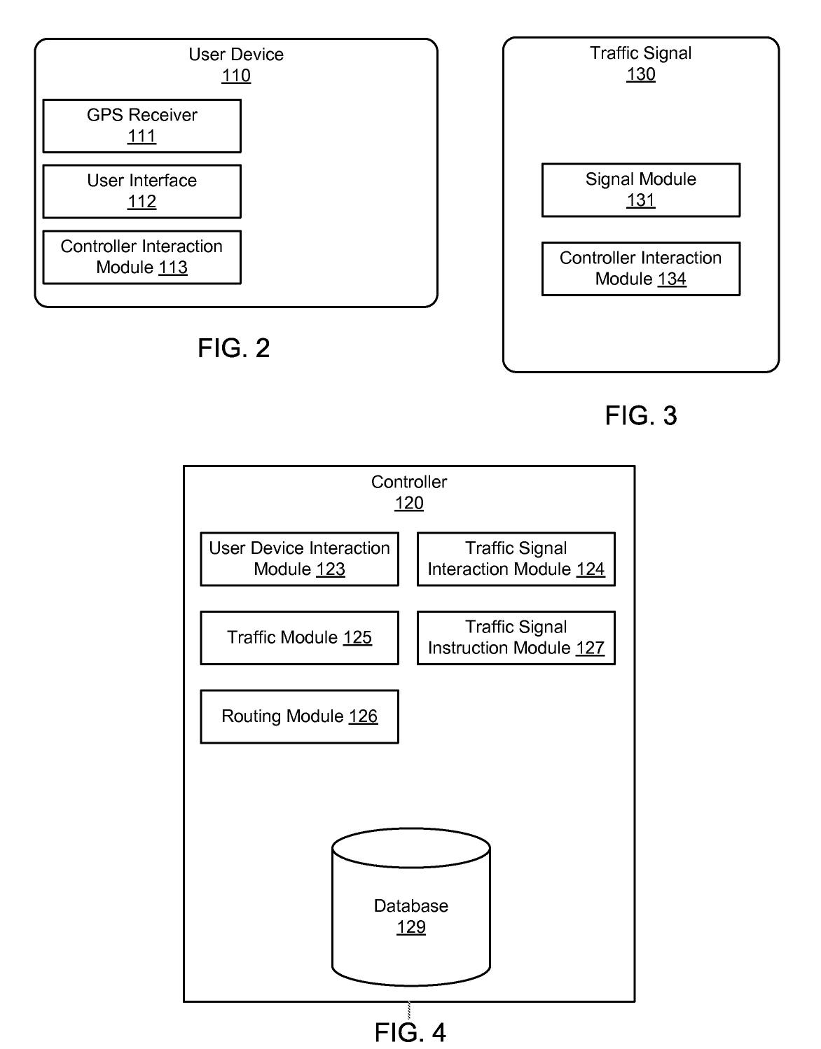

FIG. 2 is a block diagram of a user device 110, in accordance with an embodiment of the invention. The user device 110 is in the vehicle with the driver when in operation in the system 100. The user device 110 includes a GPS receiver 111, a user interface 112, and a controller interaction module 113.

The GPS receiver 111 of the user device 110 functions to identify a precise location of the user device 110 from GPS satellite system signals received at the user device 110. Suitable GPS receivers are commonly found in handheld computing devices such as cell phones, on-board navigation systems, and other electronics. The GPS receiver 111 determines the location of the user device 110 for communication to the controller 120. Alternatively, cellular signals or other known location-determining technologies may be used to determine the position of the user device 110. For clarity, the location is discussed herein as having been determined from GPS signals although GPS signals, cellular signals or other technologies can be used in alternate embodiments.

The user interface 112 of the user device 110 allows the user to input information into the user device 110 and displays information to the user. For example, the user may input a desired destination into the user interface 112 of the user device 110. The user interface 112 may display directions or a route to travel to arrive at the desired destination. The user interface 112 may also display other information relevant to the driver derived from the GPS signals received by the GPS receiver 111, received from the controller 120, or from other sources, such as current rate of speed, approaching traffic signals and the light status of approaching traffic signals, and the like.

The controller interaction module 113 of the user device 110 manages the communication between the user device 110 and the controller 120. Specifically, the controller interaction module 113 sends the location information determined by the GPS receiver 111 to the controller 120 and receives the controller's messages to the user device 110 regarding traffic, navigation routes, traffic signals, and the like.

FIG. 3 is a block diagram of a traffic signal 130, in accordance with an embodiment of the invention. The traffic signal 130 includes a signal module 131 and a controller interaction module 134.

The signal module 131 processes instructions to turn the traffic signal lights off and on and processes instructions regarding the timing of the light cycles (e.g., from green to red back to green, or in other cases from green to yellow to red and back to green). The signal module 131 may be programmed with a set of default rules for timing of the light cycles based on time of day, day of week, etc. In one embodiment, these default rules are subject to be changed based on instructions received from the controller 120. In other embodiments, the controller 120 instructs the signal module 131 of the traffic signal 130 with respect to every change in status of the light. In yet another embodiment, the controller 120 does not influence the operation of the traffic signal.

The controller interaction module 134 of the traffic signal 130 manages the communication between the controller 120 and the traffic signal 130. Specifically, in one embodiment, the controller interaction module 134 receives the instructions from the controller 120 and passes them to the signal module 131 for controlling the status of the light. (In another embodiment, the controller 120 does not send instructions for controlling the status of the light.) In some embodiments, the controller interaction module 134 sends a report to the controller 120 on the updated status of the lights of the traffic signal 130.

FIG. 4 is a block diagram of a controller 120, in accordance with an embodiment of the invention. The controller includes a user device interaction module 123, a traffic signal interaction module 124, a traffic module 125, a routing module 126, a traffic signal instruction module 127, and a database 129.

The user device interaction module 123 of the controller 120 manages the communication with the user device 110 from the controller's side. The user device interaction module 123 receives location information and optionally destination information from the controller interaction modules 113 of the user devices 110 and sends traffic, routing, or traffic signal related information to the user devices 110 via the user device interaction module 123. Likewise, the traffic signal interaction module 124 of the controller manages the communication with the traffic signal 130 from the controller's side. The traffic signal interaction module 124 may send instructions to the traffic signals 130 and may receive status updates regarding the status of the lights of the traffic signals 130 in various embodiments.

The traffic module 125 receives the location information identifying the location and, in some embodiments speed, of the user devices 110 from the user device interaction modules 123 and stores the information in a database 129. The traffic module 125 may also store information regarding traffic conditions from other sources such as other users with user devices 110, traffic services, news reports, and the like. The traffic module 125 may also receive data regarding events likely to influence traffic such as construction projects, emergency vehicle activity, and the like. The traffic module analyzes the received traffic data to determine current and in some embodiments predicted future traffic conditions, and the traffic module 125 may report traffic conditions through the user device interaction module 123 to the user devices 110.

The routing module 126 combines the information communicated to the controller 120 about the locations of the user devices 110 and optionally their destinations with the traffic conditions assessed by the traffic module 125 to prepare routing instructions for the user devices 110. In some embodiments the assessment includes observed traffic conditions, predictive analysis, or both. The routing module 126 may also consider the status and timing of the traffic signals 130 to recommend routes and speeds that result in less time for drivers spent waiting at red lights or that are otherwise advantageous, as well as to provide predicted speeds for all or part of a recommended route.

In embodiments in which the controller 120 influences traffic signals, the traffic signal instruction module 127 combines information communicated to the controller 120 about the locations of the user devices 110 and optionally their destinations with the traffic conditions assessed by the traffic module 125 to prepare instructions regarding when to turn lights off and on and the appropriate timing for the cycle of lights. The traffic signal instruction module 127 may be programmed with a set of rules regarding constraints. For example, emergency responder vehicles may be given priority to reach their destinations without interruption by stoplights. Further constraints may include a maximum limit to the time length of a light, the maximum number of cars waiting for a light to change, the relative timing or synchronization between lights, and so forth. In one embodiment yet another constraint is presence of one or more other vehicles being routed and tracked by the system 100. For example, it may be known that a tracked vehicle will trigger a light's proximity sensor and cause it to cycle, because the system 100 is routing the vehicle on a known path and is aware of the vehicle's position.

A single database 129 is shown in FIG. 4 as internal to the controller 120, however in other embodiments, the database 129 may comprise a plurality of data stores, some or all of which may reside remotely from the controller 120. For example, the data stores may be elsewhere on the network 101 as long as they are in communication with the controller 120. The database 129 is used to store user device locations, traffic conditions, alternative navigation routes and maps, traffic signal information including locations and traffic signal instructions, and any other data used by the controller for purposes such as analysis or communication with user devices 110 or the traffic signals 130.

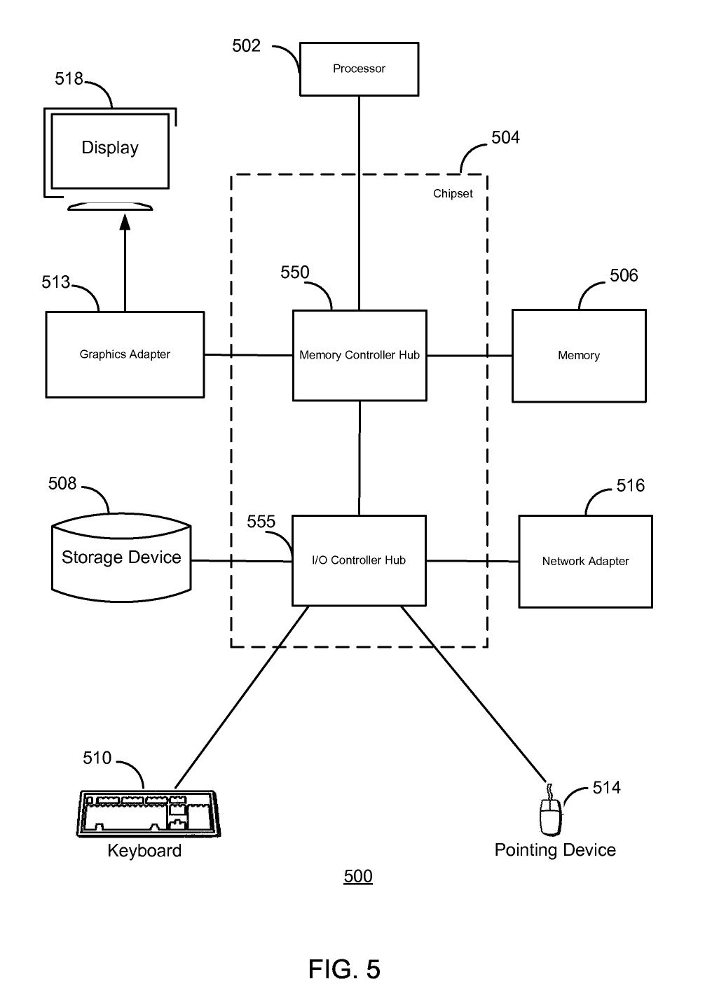

FIG. 5 is high-level block diagram illustrating an example of a computer 500 for use as a user device 110, a controller 120 or a traffic signal 130, in accordance with an embodiment of the invention. Illustrated are at least one processor 502 coupled to a chipset 504. The chipset 504 includes a memory controller hub 550 and an input/output (I/O) controller hub 555. A memory 506 and a graphics adapter 513 are coupled to the memory controller hub 550, and a display device 518 is coupled to the graphics adapter 513. A storage device 508, keyboard 510, pointing device 514, and network adapter 516 are coupled to the I/O controller hub 555. Other embodiments of the computer 500 have different architectures. For example, the memory 506 is directly coupled to the processor 502 in some embodiments.

The storage device 508 is a computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and in some embodiments is used in combination with the keyboard 510 to input data into the computer system 500. The graphics adapter 513 displays images and other information on the display device 518. In some embodiments, the display device 518 includes a touch screen capability for receiving user input and selections. The network adapter 516 couples the computer system 500 to the network 101. Some embodiments of the computer 500 have different and/or other components than those shown in FIG. 5.

The computer 500 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 508, loaded into the memory 506, and executed by the processor 502.

The types of computers 500 used by the entities of FIG. 1 can vary depending upon the embodiment and the processing power used by the entity. For example, a user device 110 that is a PDA typically has limited processing power, a small display 518, and might lack a pointing device 514. The controller 120, in contrast, may comprise multiple blade servers working together to provide the functionality described herein.

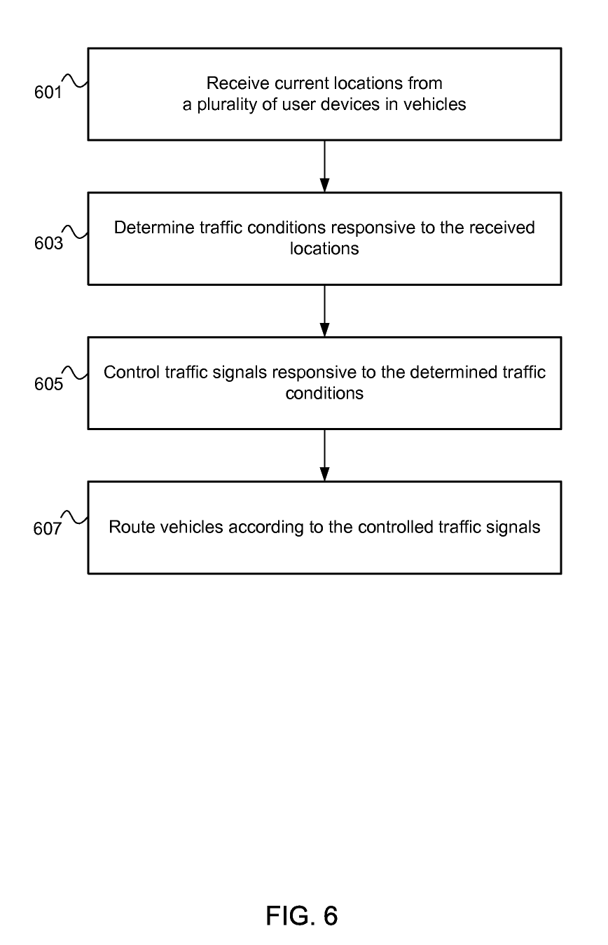

FIG. 6 is a flow chart illustrating a method of providing improved traffic routing. In step 601, the current locations (and in some embodiments, speeds) are received from a plurality of user devices 110 in vehicles. The current locations may be ascertained using GPS or other signals by the user devices 110 and communicated to the controller 120 via the network 101, for example. In some embodiments, the destinations of the users are also communicated from the user devices 110 to the controller 120.

In step 603, the traffic conditions are determined responsive to the received locations of the user devices 110. In some cases, the traffic conditions are also determined responsive to other sources of traffic information such as traffic websites, traffic services, etc. In one embodiment, roadwork and emergency vehicle activity are also considered in determining the traffic conditions. In one embodiment, system 100 provides predictive modeling of anticipated traffic speeds based on the various sources of information provided to system 100.

In step 605, optionally, traffic signals are controlled responsive to the determined traffic conditions. For example, instructions are sent from controller 120 to individual traffic signals 130 to turn them on or off or adjust the timing of the light cycles to ease congestion identified in the traffic conditions.

In step 607, vehicles are routed according to the controlled traffic signals. For example, the controller 120 may send route information or speed information to the user devices 110 to enable the drivers of the vehicles in which the user devices 110 reside to avoid red lights and/or avoid congested areas if the instructions from the controller 120 with respect to the route information or speed information are obeyed.

Embodiments of the present invention that provide systems, methods, and computer-readable storage media that use location-based technologies such as GPS to provide improved traffic routing have been described above. Benefits of embodiments of the invention include:

1. Better synchronization of drivers and traffic lights. As a result, people can spend less time waiting at traffic lights. Additionally, better synchronization results in drivers being able to maintain a more constant speed and avoid abrupt accelerations and decelerations caused by stopping at traffic lights. Reduced acceleration/deceleration while driving results in increased miles per gallon of gas for cars and reduced carbon emissions. The better synchronization of drivers and traffic lights results in tangible benefits to everyone, including drivers who do not use the user devices 110, because embodiments of the invention avoid gridlock and generally improve the flow of traffic. Thus, helping a relative handful of drivers who use the user devices 110 to proceed smoothly will also help alleviate the burdens of traffic to the rest of the drivers.

2. Improved ability to clear roads for emergency responders. Not only can traffic lights be informed of an emergency response vehicle approaching in order to block cross traffic to avoid an accident, but also can turn appropriate lights green to relieve congestion in the path of an emergency response vehicle. Non-emergency traffic, meanwhile, is routed elsewhere so that by the time an emergency vehicle arrives at an intersection, there are fewer other vehicles in contention with it.

3. Improved ability to support mass transit. The traffic lights can be preferentially managed to support buses, trolleys, and trains to avoid having these mass transit vehicles wait for traffic lights. In addition, cars can be managed to avoid having to wait for trains or other mass transit vehicles.

4. Load balancing during busy periods. The traffic lights and signals to drivers can be managed so as to balance the traffic between a number of known traffic bottlenecks or popular routes (such as multiple bridges across a single river, and main thoroughfares into or out of an urban area).

5. Synchronization of drivers with each other. In one particular embodiment, drivers are directed among a plurality of routes according to characteristics of the vehicle, the driver, or the desired destination. For example, all trucks are directed to one thoroughfare and all cars are directed to another. This helps avoid the inconveniences to car and truck drivers of travelling on the same route. Namely, trucks reduce the visibility that smaller cars have of the road and trucks' longer acceleration times can frustrate car drivers. The shorter breaking distance of cars compared to trucks increases the risk of collisions when both are travelling the same route. Also, truck drivers prefer to travel near other trucks to save on fuel by drafting off of each other. As another example, everyone on route A plans to exit in no less than 5 miles, whereas everyone on route B plans to exit in less than 5 miles. This may improve traffic flow through congested areas.

6. Prediction and avoidance of congestion. Drivers can be routed around congested areas, thus easing congestion. This results in less driving time and lower carbon emissions.

7. Improved traffic monitoring. The results of accurate traffic monitoring can be used in many applications, such as to plan new roads and improvements to infrastructure, or to coordinate the timing of construction projects on infrastructure to lessen the impact on drivers.

8. Accurate real-time traffic information, including on city streets. Accurate traffic information is useful for trip planning and commuting. The real-time traffic conditions could be used as inputs into various other scheduling systems to ensure timely arrivals for meetings, events, etc. For example, based on the traffic conditions for any given day, an alarm clock may be programmed to wake a person up 30 minutes before he needs to leave for work in order to arrive on time.

The discussion above addresses a system in which there is two-way communication among vehicles and traffic systems. In other embodiments, even simpler one-way communications are used. Specifically, a location-aware user device 130 such as a smart phone in a vehicle sends a message to traffic signal 130 indicating that the vehicle is approaching the traffic signal 130 from a particular direction and may also transmit the vehicle's destination. If appropriate, traffic system 130 changes its operation so as to allow the vehicle to pass with minimal slowdown. As a specific example, consider a smart phone such as the iPhone® device provided by Apple, Inc. and mentioned above. Such device is location-aware and is readily programmed by software applications to perform a variety of functions. In one specific embodiment, a software application directs the device to periodically send its location and optionally the vehicle's destination to a specified site via the Internet, for example controller 120. Depending on the vehicle's location and heading, controller 120 then sends traffic signal 130 a signal indicating that traffic is approaching from a particular direction. If appropriate (for instance during late-night hours with little expected traffic), traffic signal 130 then changes the state of its lights so as to allow the vehicle to pass without having to stop.

Such one-way communications can also be used effectively in environments having multiple vehicles with user devices 110. For example, controller 120 can compare the number of eastbound/westbound vehicles at a particular intersection with the number of northbound/southbound vehicles and cause traffic signal 130 to adjust its light cycles accordingly.

One-way communications in the other direction (i.e., from the traffic signal to vehicles) may also be effective. For instance, a software application on user device 110 may obtain from the traffic signal 130, via controller 120, an indication that a light has just turned red and will not turn green again for one minute. If the intersection is not visible to the driver, for instance because the approach is hilly or on a curve, this information can be used to tell the driver that there is no point in approaching the intersection quickly, since the vehicle will only need to wait for the green light anyway. Thus, safety can be enhanced near “blind” or otherwise dangerous intersections. In addition, knowledge of the cycle of a traffic signal from a distance can help drivers time their approaches to controlled intersections to coincide with a green light. Thus, drivers can reduce the time they spend waiting at red lights.

In one specific embodiment, users are provided incentives to keep their devices in active operation while enroute, rather than just at the outset of a journey. This is advantageous to all users of the system because the more users who are “live” on the system (e.g., have the appropriate application operating on their user devices 110), the more information can be collected from such users regarding traffic information at various locations. Using the example of an iPhone, for instance, if an “app” implementing the system is kept on during transit, not only will the user obtain updated information, but the system will obtain ongoing information from that user, such as traffic speed at the user's location.

In order to provide such incentive, a user interface of the application running on user devices 110 provides updated information during travel. In one particular embodiment, the predicted state of a light that the user is approaching is presented to the user differently depending on the certainty of the prediction. For example, a visual display of the light's predicted state can start out, when the prediction is relatively uncertain, as a rather faded color, and increase in intensity as the certainty grows. As another example, a change in a light's predicted state can be announced to the user by audio as well as visual messaging, and the proposed route can likewise be altered on the fly if an originally preferred route now appears suboptimal due to changes in the predicted state of one or more lights.

In some embodiments, traffic data collected from user devices 110 over a period of time is stored in database 129 and processed further by controller 120 to determine or refine routes proposed by routing module 126. In one specific embodiment, vehicle speed information collected over a period of time is used to determine the presence of stop signs that were not previously known by the system. Knowledge of where such stop signs are located allows the system to build in appropriate delays when considering routes that include intersections with those stop signs. Similarly, over a long period of time it may be evident that no user devices 110 have traversed a given portion of a mapped road. Such data may indicate that the road was planned but never built, that the road has been closed, or that the road is unavailable for use for some other reason. Based on such collected data, in some routing module 126 ignores such road segments as being available for a proposed route. Conversely, location and speed data from user devices 110 may indicate that a new road has been built that is not on the base map loaded into database 129, and if there is enough vehicular use of such a route, then routing module 126 assumes such a path, even though not mapped, is available for a proposed route.

Still more detailed collected and real-time information from user devices 110 is used by system 120 in certain embodiments. Real-time average vehicle speed from other vehicles, historical average vehicle speed, vehicle speed variance over time, deviation of a given user's vehicle speed compared to other vechicle's speeds over the same route (indicating an aggressive or conservative driving manner) and best/worst case speed data are all used as inputs by system 120 to predict the time it will take a vehicle corresponding to a particular user device 110 to traverse a specific segment of a possible path.

As one example, by collecting data system 100 may determine that a particular segment of road is subject to 25 mph speed limits during certain times and 40 mph speed limits during other times, for instance indicating a school zone with a reduced speed limit sign that flashes to invoke the lower limit during times when children are present. Further, system 100 determines that some users tend to be conservative and drive according to the 25 mph sign regardless of whether the lights are flashing, while others reduce speed only when the lights are flashing. For users who reduce speed all of the time, system 100 routes them based on a lower expected speed regardless of the actual speed limit; other users get routed based on an expectation that they will match the actual speed limit in effect at the time. Changes in speed limit also occur on some roadways based on time of day, vehicle type (truck or automobile), construction activity and the like. In some embodiments system 100 detects patterns in collected data indicating such changes and accounts for them in determining routes and estimating transit times.

In certain embodiments, system 100 adaptively segments routes into smaller pieces over time when collected data suggest such smaller segmentation will yield more accurate estimates of travel time. For example, system 100 may start out by considering the entirety of a street as one segment, but data collected over time may indicate that there is a school zone impacting a certain portion of the road. In response, system 100 divides the road into three segments, so that those who exit the road well before the school zone are not considered subject to the reduced speed limit that would affect a driver going past the school.

Further extending this example, school bus routes often slow traffic considerably, but only for a small portion of each day. By collecting information from user devices 110 over a period of time, system 100 may infer that during school days, certain routes that otherwise have a much higher average speed will be congested at specific known times. During those times, preference is given to routes that avoid approaching or following a school bus. Not only does such routing improve transit times, but it also increases safety by reducing the number of conflict points between vehicles and children getting on or off a bus.

Other factors that can be considered for such correlations include rush hour, weekday/weekend differences in travel, large sporting events or conventions, holiday shopping times, freight or commuter train crossings, ferries, radar speed enforcement and the like. A particular advantage of using data collected from user devices 110 for this purpose is that temporal changes in estimated segment transit times and correlations do not need to be calculated for all road segments, but only those showing significant time-dependent variations. Processing requirements for system 100 are thus dramatically reduced compared with a system configured to make temporal predictions for all road segments.

In some instances, external data sources are used instead of, or in addition to, the collected data referenced above. For example, in one embodiment significant periodic changes in observed traffic at a particular location trigger system 100 to search external data sources (such as through a location-based internet search) to determine a cause of such changes, such as presence of a school, railroad crossing or sports venue; notice of a period of road construction; or public warning that a road is only seasonal and is not maintained in winter. In such embodiments, system 100 is programmed to then search for information that correlates with the observed data and can be used to make predictions for transit time in the future. In an exemplary embodiment, should system 100 determine, by a location-based search, that a school is located where there are large variations in transit time, system 100 then searches the Internet for a school calendar and extracts information as to what days the school is open so that the system can predict when traffic is likely to be slowed down in the vicinity of the school.

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A traffic communication system, comprising:
a traffic signal having a plurality of states;
a traffic signal subsystem operatively connected to the traffic signal and configured to receive from the traffic signal a notification of when the traffic signal is in each of the plurality of states and to produce therefrom a prediction; and
a routing subsystem configured to receive from the traffic signal subsystem the prediction and, responsive thereto, determine a proposed route and transmit the proposed route to a first user device.

2. The traffic communication system of claim 1, further comprising a traffic data subsystem configured to receive from a second user device traffic data including speed and location, wherein the traffic data subsystem is configured to process the traffic data and, responsive thereto, communicate with the routing subsystem.

3. The traffic communication system of claim 2, wherein the routing subsystem is further configured to determine the proposed route responsive to the traffic data.

4. The traffic communication system of claim 1, wherein the routing subsystem is further configured to transmit to the first user device an indication of which of the states the traffic signal will be in at a user arrival time, responsive to the prediction.

5. The traffic communication system of claim 4, wherein the first user device is configured to provide a visual display responsive to the indication, the visual display including a measure of certainty.

6. The traffic communication system of claim 5, wherein the measure of certainty is an intensity of color.

7. The traffic communication system of claim 4, wherein the first user device is configured to provide an audible presentation responsive to the indication.

8. The traffic communication system of claim 7, wherein the audible presentation includes a measure of certainty.

9. The traffic communication system of claim 1, wherein the traffic signal subsystem is configured to produce an updated prediction subsequent to producing the prediction, and wherein the routing subsystem is configured to receive from the traffic signal subsystem the updated prediction and, responsive thereto, determine a revised route and transmit the revised route to the first user device.

10. The traffic communication system of claim 1, further comprising a traffic data subsystem configured to receive traffic data including at least one of congestion data, emergency vehicle data, construction data, accident data, and weather data, wherein the traffic data subsystem is configured to process the traffic data and, responsive thereto, communicate with the routing subsystem.

11. The traffic communication system of claim 1, further comprising a traffic signal instruction module communicatively coupled with the routing subsystem, the traffic signal instruction module configured to instruct the traffic signal to enter a select one of the plurality of states responsive to a time of arrival at the traffic signal.

12. The traffic communication system of claim 1, wherein the routing subsystem is further configured to transmit a proposed speed responsive to operation of the traffic signal.

13. The traffic communication system of claim 1, further comprising at least one additional traffic signal operatively connected to the traffic signal subsystem and configured to provide thereto at least one additional state notification, the traffic signal subsystem configured to produce therefrom at least one additional prediction, the routing system configured to determine the proposed route responsive to the at least one additional prediction.

14. The traffic communication system of claim 2, wherein the first user device is also the second user device.

15. The traffic communication system of claim 2, wherein the first user device is identical to the second user device.

16. The traffic communication system of claim 1, wherein the routing subsystem is further configured to determine the proposed route responsive to traffic-related information, the traffic-related information including at least one of: stop signs, time of day, time of week, time of year, school operations, sporting events, conventions, speed enforcement operations, holidays, train operations, bus operations, unmapped roadways, closed roads, uncompleted roads, driver aggressiveness, historical average speed, historical speed variance, best-case observed speed, worst-case observed speed, and temporal variations in legal speed limit.

17. A user routing device, comprising:
a computer readable medium storing a program, the program including instructions to:
transmit to a traffic system a route request;
receive from the traffic system a proposed route, the proposed route being responsive to operational states of a traffic signal;
indicate to the user a predicted one of the operational states based on estimated time of arrival at the traffic signal; and
a processor configured to communicate with the computer readable medium and to execute the program.

18. The user routing device of claim 17, wherein the program further includes instructions to:
determine traffic information from the user device, the traffic information including location and speed; and
transmit the traffic information to the traffic system.

19. The user routing device of claim 17, wherein the program further includes instructions to indicate to the user whether to speed up or slow down, responsive to the predicted one of the operational states based on estimated time of arrival at the traffic signal.

20. The user routing device of claim 17, wherein the program further includes instructions to indicate to the user a measure of certainty regarding the predicted one of the operational states based on estimated time of arrival at the traffic signal.

21. The user routing device of claim 17, wherein the proposed route is further responsive to ability of the traffic system to send the traffic signal a request to enter one of the operational states in response to an expected arrival time at the traffic signal.

22. A traffic information collection system, comprising:
a routing subsystem responsive to traffic data, the traffic data including traffic light state data;
a plurality of user routing devices, communicatively coupled with the routing subsystem and configured to receive recommended route information from the routing subsystem responsive to the traffic data; and
a traffic database subsystem, communicatively coupled with the plurality of user routing devices and configured to receive the traffic information from the plurality of user routing devices.

23. A computer-implemented method of communicating traffic information to a vehicle, comprising:
receiving, by a traffic signal subsystem operatively connected to a traffic signal, a notification of when the traffic signal is in each of a plurality of states and producing therefrom a prediction;
receiving, by a routing subsystem, the prediction; and
responsive to the prediction, determining a proposed route and transmitting the proposed route to the vehicle.

24. The method of claim 23, further comprising receiving from a second vehicle traffic data including speed and location, and communicating the traffic data to the routing subsystem for use in determining the proposed route.

25. The method of claim 23, further comprising transmitting to the vehicle an indication of which of the states the traffic signal will be in when the vehicle arrives at the traffic signal, responsive to the prediction.

26. The method of claim 25, wherein the indication provides a measure of certainty.

27. The method of claim 26, wherein the measure of certainty is represented by an intensity of color.

28. The method of claim 25, wherein the indication provides an audible presentation.

29. The method of claim 28, wherein the audible presentation includes a measure of certainty.

30. The method of claim 23, further including producing an updated prediction subsequent to producing the prediction, and responsive to the updated prediction, determining a revised route and transmitting the revised route to the vehicle.

31. The method of claim 23, further comprising receiving traffic data including at least one of congestion data, emergency vehicle data, construction data, accident data, and weather data, processing the traffic data and, responsive thereto, communicating with the routing subsystem.

32. The method of claim 23, further comprising instructing the traffic signal to enter a select one of the plurality of states responsive to a time of arrival of the vehicle at the traffic signal.

33. The method of claim 23, further comprising transmitting to the vehicle a proposed speed responsive to operation of the traffic signal.

34. The method of claim 23, further comprising obtaining state information from at least one additional traffic signal, producing therefrom at least one additional prediction, and determining the proposed route responsive to the at least one additional prediction.

35. The method of claim 23, further comprising:
collecting, from a plurality of vehicles, traffic-related information;
correlating the traffic information;
forming an inference responsive to the correlating; and
determining the proposed route responsive to the inference.

36. The method of claim 23, wherein the inference is presence of at least one of: a stop sign, a school, a railroad crossing, a bus, radar enforcement operations, an event venue, an unmapped roadway, road construction, a closed roadway, an uncompleted road, a ferry, a roadway subject to multiple speed limits, a level of driver aggressiveness, and a type of vehicle.

37. A traffic control method, comprising:
transmitting a route request from a user to a traffic system;
receiving a proposed route from the traffic system, the proposed route being responsive to operational states of a traffic signal; and
indicating to the user a predicted operational state based on estimated time of arrival at the traffic signal.

38. The method of claim 37, further comprising:
determining traffic information from a user device, the traffic information including location and speed; and
transmitting the traffic information to the traffic system.

39. The method of claim 37, further comprising indicating to the user whether to speed up or slow down, responsive to the predicted operational state based on estimated time of arrival at the traffic signal.

40. The method of claim 37, further comprising indicating to the user a measure of certainty regarding the predicted operational state based on estimated time of arrival at the traffic signal.

41. The method of claim 37, further comprising sending a request to the traffic signal to enter one of the operational states in response to an expected arrival time at the traffic signal.

42. The method of claim 37, further comprising inferring presence of traffic-related features responsive to collected data from a plurality of vehicles, and determining the proposed route responsive to the inferring.

43. The method of claim 37, further comprising inferring presence of traffic-related features responsive to collected data from a plurality of vehicles, and indicating the predicted operational state responsive to the inferring.

44. A computer-implemented method of obtaining traffic information, comprising:
providing mobile users, via software applications executing on mobile user devices, routing and traffic data relating to traffic signal status and other current parameters relating to traffic; and
obtaining the traffic information from the mobile user devices, via the software applications.

45. A computer-implemented method of determining traffic-related information, comprising:
collecting, over a period of time, speed and position information from mobile user devices, via software applications; and
correlating the speed and position information to infer therefrom the traffic-related information.

46. The method of claim 45, wherein the traffic-related information includes presence of at least one of: a stop sign, a school, a convention center, a ferry, a railroad crossing, a bus stop, an unmapped roadway, a closed road, an uncompleted road, road construction operations, speed enforcement operations, and time-varying speed limits.

47. The method of claim 45, further comprising determining a proposed route responsive to the inferred traffic-related information.
